(19) United States
(12) Patent Application Publication
(10) Pub. No.: US 2025/0087934 A1
(43) Pub. Date: Mar. 13, 2025

(54) CONNECTOR

(71) Applicant: YAZAKI CORPORATION, Tokyo (JP)

(72) Inventors: Motohide Sato, Makinohara-shi (JP); Tomoaki Hayakawa, Makinohara-shi (JP)

(21) Appl. No.: 18/811,721

(22) Filed: Aug. 21, 2024

(30) Foreign Application Priority Data
Sep. 13, 2023 (JP) 2023-148349

(51) Int. Cl. H01R 13/52

(52) U.S. Cl. CPC H01R 13/5208

(57) ABSTRACT

A connector includes a housing, a plurality of terminals that are respectively connected to a plurality of electric wires and are accommodated in the housing, a packing that is attached to the plurality of electric wires in a manner of collectively packing the plurality of electric wires and is accommodated in the housing, and a holder that is assembled to the housing and restricts separation of the packing from the housing. The packing includes a plurality of electric wire through holes through which the plurality of electric wires are respectively inserted and a recessed portion located between the adjacent electric wire through holes among the plurality of electric wire through holes. The holder includes a protrusion portion to be fitted into the recessed portion of the packing.

### CROSS-REFERENCE TO RELATED APPLICATIONS

This application is based on and claims priority under 35 USC 119 from Japanese Patent Application No. 2023-148349 filed on Sep. 13, 2023, the contents of which are incorporated herein by reference.

### TECHNICAL FIELD

The present invention relates to a connector.

### BACKGROUND ART

The related art discloses a connector including a housing, a plurality of terminals that are respectively connected to a plurality of electric wires and are accommodated in the housing, a packing (a rubber plug) that is attached to the plurality of electric wires and closes a rear opening of the housing, and a rear holder that is assembled to a rear end of the housing and restricts separation of the packing (for example, see Patent Literatures 1 and 2).

### CITATION LIST

### Patent Literature

Patent Literature 1: JP2014-183002A
Patent Literature 2: JP2023-96350A

### SUMMARY OF INVENTION

In Patent Literature 1, a plurality of packings are provided, and the plurality of packings are respectively attached to the plurality of electric wires. In this case, a packing needs to be attached to each of the plurality of electric wires, and manufacturing work tends to be complicated.

In Patent Literature 2, a single packing is provided, and the single packing is attached in a manner of collectively packing a plurality of electric wires. In this case, since the packing can be attached in a manner of collectively packing the plurality of electric wires, manufacturing workability is good, but a waterproof property may be lowered due to uneven pressure applied to the packing. Specifically, the packing is generally accommodated in a housing in a manner of being in elastic contact with an inner wall of the housing from the viewpoint of waterproof property. Therefore, pressure (stress) is applied to the packing from the inner wall or the like of the housing, and a hole edge of an electric wire through hole (a through hole through which each of the plurality of electric wires is inserted) is brought into close contact with an electric wire, and the packing is elastically deformed. However, pressure applied to a portion between the adjacent electric wire through holes in the packing tends to be smaller than that applied to the other positions. When the pressure applied to the packing is biased in this manner, the packing is elastically deformed without bringing a side of the hole edge between the adjacent electric wire through holes into sufficient close contact with the electric wire, a gap occurs between the hole edge and the electric wire, and a waterproof property may be lowered.

The present invention has been made in view of the above circumstances, and an object of the present invention is to provide a connector having improved manufacturing workability and waterproof property.

To achieve the above object, the connector according to the present invention has the following features.

The connector according to the present invention includes a housing; a plurality of terminals that are respectively connected to a plurality of electric wires and are accommodated in the housing; a packing that is attached to the plurality of electric wires in a manner of collectively packing the plurality of electric wires and is accommodated in the housing; and a holder that is assembled to the housing and restricts separation of the packing from the housing. The packing includes a plurality of electric wire through holes through which the plurality of electric wires are respectively inserted and a recessed portion located between the adjacent electric wire through holes among the plurality of electric wire through holes, and the holder includes a protrusion portion to be fitted into the recessed portion of the packing.

According to the present invention, since a packing is attached in a manner of collectively packing a plurality of electric wires, manufacturing workability is improved as compared with a case where a plurality of packings are respectively attached to a plurality of electric wires.

Here, in the packing that is attached in a manner of collectively packing a plurality of electric wires, in general, a bias is likely to occur in pressure applied from an inner wall or the like of a housing. In particular, pressure applied between adjacent electric wire through holes in the packing tends to be smaller than that applied to the other portions, and a side of a hole edge of each electric wire through hole between adjacent electric wire through holes may be not in sufficient contact with each electric wire. However, according to the present invention, a recessed portion is provided in the packing between adjacent electric wire through holes among a plurality of electric wire through holes, and a protrusion portion of a holder is fitted into the recessed portion, so that pressure substantially equal to that applied to the other portions is applied between the adjacent electric wire through holes in the packing. Accordingly, a side of the hole edge of each electric wire through hole between the adjacent electric wire through holes is in sufficient close contact with each electric wire, and therefore, a waterproof property is improved as compared with the related art.

That is, according to the present invention, both manufacturing workability and waterproof property can be achieved as described above.

The present invention has been briefly described above. Further, details of the present invention can be further clarified by reading modes (hereinafter, referred to as “embodiments”) for carrying out the invention to be described below with reference to the accompanying drawings.

### BRIEF DESCRIPTION OF DRAWINGS

FIG. 1 is an exploded perspective view showing main portions of a connector according to an embodiment of the present invention as viewed from a rear side;

FIG. 2 is a rear perspective view showing a packing shown in FIG. 1;

FIG. 3 is a rear view of FIG. 2;

FIG. 4 is a front perspective view showing a rear holder shown in FIG. 1;

FIG. 5 is a front view of FIG. 4; and

FIG. 6 is a cross-sectional view showing main portions of the connector shown in FIG. 1.

### DESCRIPTION OF EMBODIMENTS

Hereinafter, a connector 1 according to an embodiment of the present invention will be described with reference to the drawings.

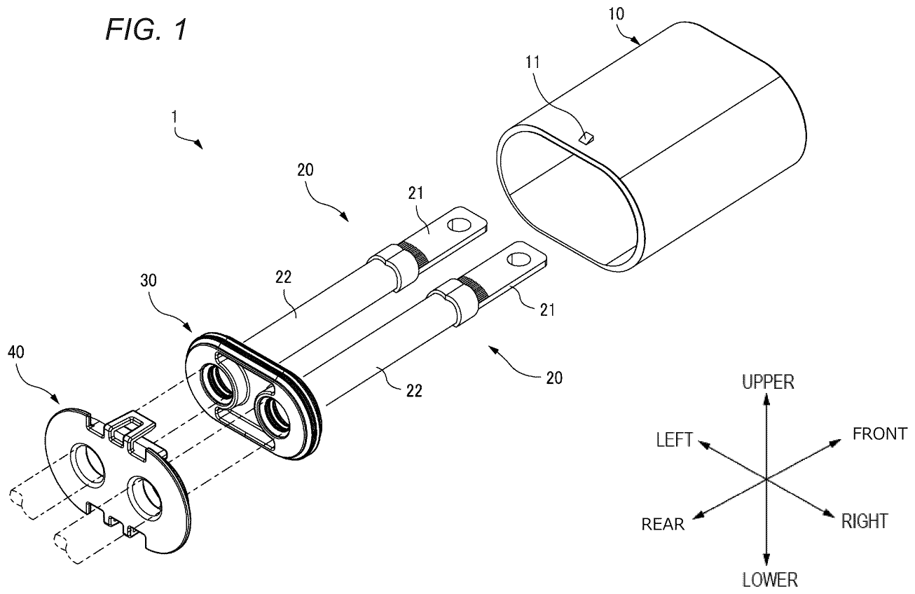

Hereinafter, for convenience of description, as shown in FIG. 1 or the like, “front”, “rear”, “left”, “right”, “upper”, and “lower” are defined. A “front-rear direction”, a “left-right direction”, and an “upper-lower direction” are orthogonal to one another. The left-right direction corresponds to an “arrangement direction” in the present invention. The front-rear direction corresponds to an “axial direction” in the present invention.

As shown in FIG. 1, the connector 1 includes a housing 10, a plurality of terminal-attached electric wires 20 (two terminal-attached electric wires in the present example), a packing 30, and a rear holder 40. Hereinafter, the housing 10, the terminal-attached electric wire 20, the packing 30, and the rear holder 40 that constitute the connector 1 will be described in order.

First, the housing 10 will be described. The housing 10 is formed in, for example, a substantially elliptical cylindrical shape (see FIG. 1), and terminals 21 are held inside the housing 10 (a cylinder hole). In the housing 10, the terminal-attached electric wires 20 (the terminals 21) are accommodated from the rear, the packing 30 is accommodated in a manner of stopping water at a rear opening, and then the rear holder 40 is assembled to a rear end portion. For example, the housing 10 is fitted to a housing (not shown) of counterpart connector. The housing 10 is provided with locking protrusions 11 corresponding to locking arms 45 of the rear holder 40 to be described later. By locking the locking arms of the rear holder 40 to the locking protrusions 11, the rear holder 40 is assembled to the housing 10.

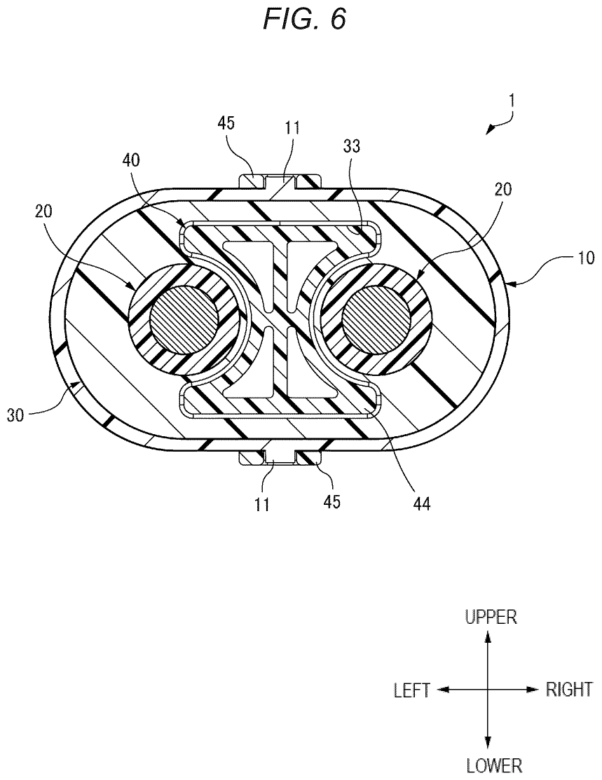

Next, the terminal-attached electric wire 20 will be described. As shown in FIG. 1, the terminal-attached electric wire 20 includes the terminal 21 and an electric wire 22. The terminal 21 is accommodated in the housing 10 and electrically connected to a terminal (not shown) of the counterpart connector. A front end portion of the electric wire 22 is connected to the terminal 21. The electric wire 22 is formed of a conductor and an insulating sheath (reference numerals are omitted, see FIG. 6), and is connected to, for example, a device mounted in a vehicle.

Next, the packing 30 will be described. The packing 30 is made of, for example, rubber, and is attached to the plurality of electric wires 22 in a manner of collectively covering the electric wires 22 of the plurality of terminal-attached electric wires 20. The packing 30 is brought into elastic contact with an inner surface of a peripheral wall of the housing 10 in a state where the packing 30 is accommodated in the housing 10, and has a function of preventing liquid such as water from entering the housing 10 from the rear opening, that is, stopping water at the rear opening of the housing 10.

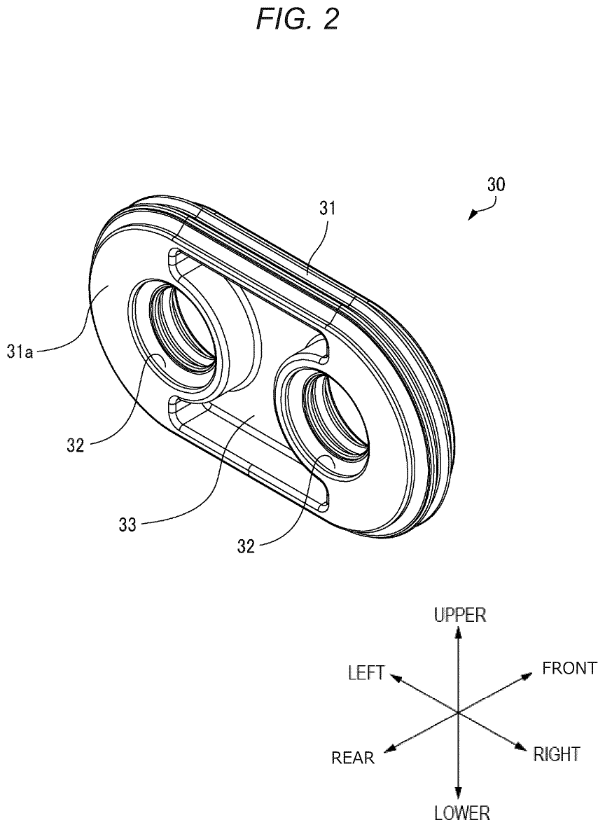

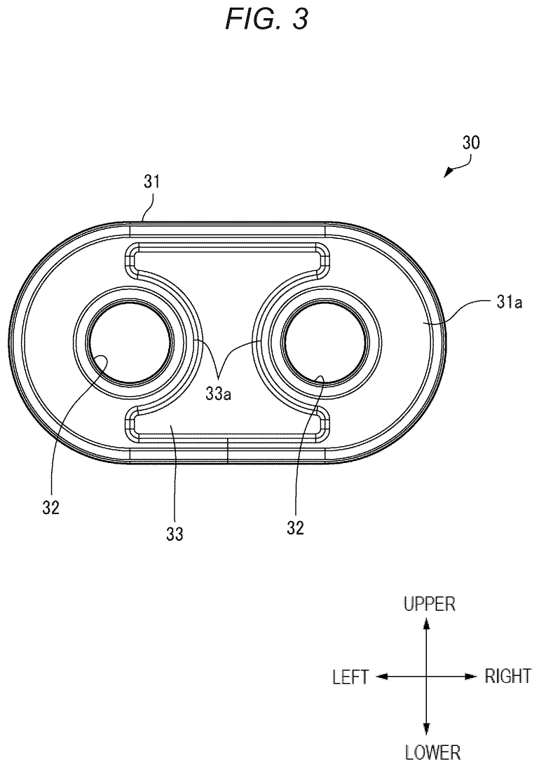

As shown in FIGS. 2 and 3, the packing 30 has a body portion 31 having a substantially elliptical shape corresponding to an opening shape of the housing 10. The body portion 31 is provided with a plurality of electric wire through holes 32 (two electric wire through holes in the present example) that pass through the body portion 31 in the front-rear direction and are arranged side by side in the left-right direction corresponding to the electric wires 22 of the plurality of terminal-attached electric wires 20.

A recessed portion 33 recessed forward is provided in a rear surface 31a of the body portion 31 between the electric wire through holes 32 adjacent to each other in the left-right direction. A protrusion portion 44 of the rear holder 40 to be described later is fitted into the recessed portion 33 (see FIG. 6).

The recessed portion 33 is formed with a pair of wall portions 33a facing each other in the left-right direction, and each of the wall portions 33a is formed in a curved shape along a peripheral edge of each of the adjacent electric wire through holes 32 adjacent to each wall portion 33a. In other words, the left wall portion 33a of the recessed portion 33 has a curved shape along the peripheral edge of the left electric wire through hole 32 of the adjacent electric wire through holes 32, and the right wall portion 33a of the recessed portion 33 has a curved shape along the peripheral edge of the right electric wire through hole 32 of the adjacent electric wire through holes 32. Each wall portion 33a is formed to cover a half circumference of the peripheral edge of each electric wire through hole 32 in a rear view (see FIG. 6). That is, the wall portion 33a is formed in a semicircular arc shape in a rear view.

Next, the rear holder 40 will be described. The rear holder 40 is assembled to a rear end portion of the housing 10 (see FIG. 6) and has a function of restricting separation of the packing 30 from the housing 10.

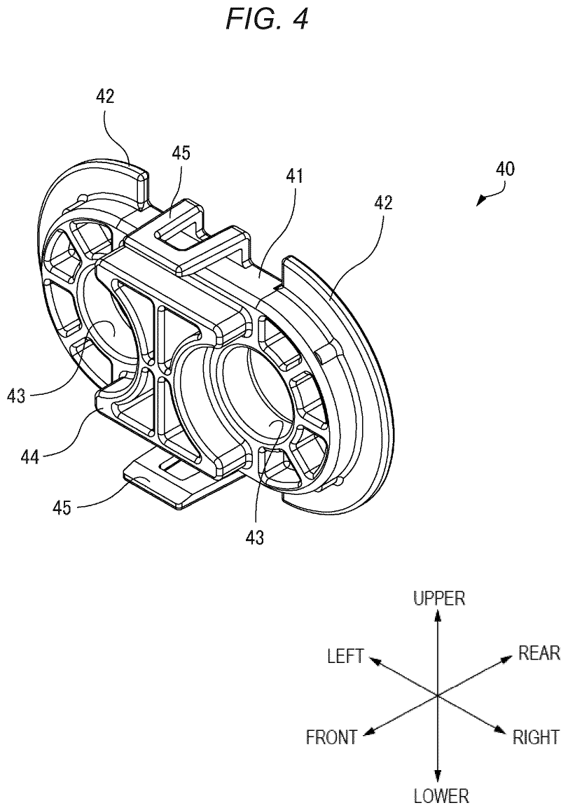

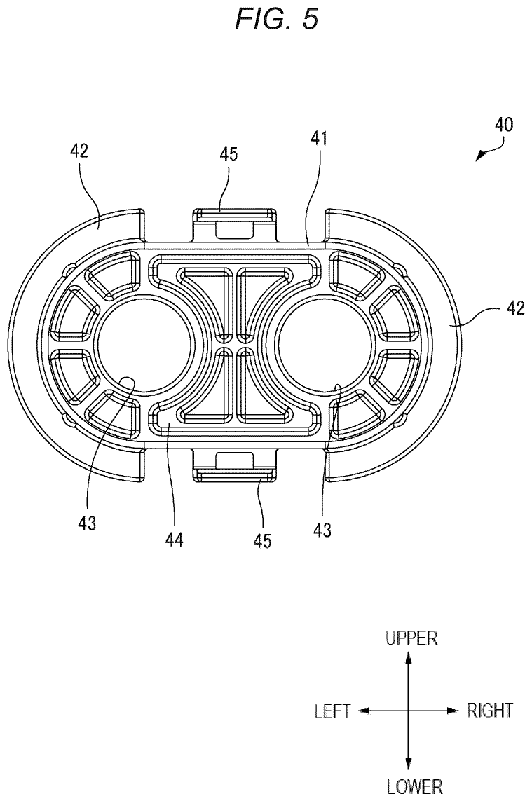

As shown in FIGS. 4 and 5, the rear holder 40 has a body portion 41 having a substantially elliptical shape corresponding to the opening shape of the housing 10. A pair of flange portions 42 are provided on both left and right rear portions of an outer peripheral surface of the body portion 41 so as to sandwich a pair of locking arms 45 to be described later in the left-right direction. For example, the flange portion 42 is brought into contact with an opening end edge of a rear opening of the housing 10 in a state where assembly of the rear holder 40 to the housing 10 is completed.

The body portion 41 is provided with a plurality of electric wire through holes 43 (two electric wire through holes in the present example) that pass through the body portion 41 in the front-rear direction and are arranged side by side in the left-right direction corresponding to the electric wires 22 of the plurality of terminal-attached electric wires 20.

Corresponding to the recessed portion 33 of the packing 30, the protrusion portion 44 protruding forward is provided on a front surface of the body portion 41 between the electric wire through holes 43 adjacent to each other in the left-right direction. The protrusion portion 44 is fitted into the recessed portion 33 of the packing 30 (see FIG. 6).

The locking arms 45 extending forward are provided between the pair of flange portions 42 respectively on upper and lower sides of an outer peripheral surface of the body portion 41. The locking arms 45 are formed in a so-called cantilever shape and are elastically deformable. The rear holder 40 is assembled to the housing 10 by locking the locking arms 45 to the locking protrusions 11 of the housing 10.

The housing 10, the terminal-attached electric wires 20, the packing 30, and the rear holder 40 that constitute the connector 1 have been described above. Hereinafter, an example of a method for manufacturing the connector 1 will be described.

First, the packing 30 is attached in a manner of collectively packing the electric wires 22 of the plurality of terminal-attached electric wires 20 from a rear side, and then the rear holder 40 is attached. Then, the terminals 21 of the terminal-attached electric wires 20 are inserted from the rear opening of the housing 10, and the terminals 21 are accommodated in the housing 10.

Next, the packing 30 is moved to insert the packing 30 from the rear opening of the housing 10, and the packing 30 is accommodated in the housing 10.

Next, the rear holder 40 is moved to fit the protrusion portion 44 of the rear holder 40 into the recessed portion 33 of the packing 30, and the locking arms 45 of the rear holder 40 are locked to the locking protrusions 11 of the housing 10. Thus, the rear holder 40 is assembled to a rear end portion of the housing 10, and the connector 1 is completed. The method for manufacturing the connector 1 has been described above.

As descried above, according to the present embodiment, since the packing 30 is attached in a manner of collectively packing the plurality of electric wires 22, manufacturing workability is improved as compared with a case where a plurality of packings are respectively attached to a plurality of electric wires.

Here, in the packing that is attached in a manner of collectively packing a plurality of electric wires, in general, a bias is likely to occur in pressure applied from an inner wall or the like of a housing. In particular, pressure applied between adjacent electric wire through holes in the packing tends to be smaller than that applied to the other portions, and a hole edge of each electric wire through hole may be not in sufficient contact with each electric wire. However, according to the present embodiment, the recessed portion 33 is provided in the packing 30 between the adjacent electric wire through holes 32 among the plurality of electric wire through holes 32, and the protrusion portion 44 of the holder 40 is fitted into the recessed portion 33, so that pressure substantially equal to that applied to the other portions is applied between the adjacent electric wire through holes 32 in the packing 30. Accordingly, a side of a hole edge of each electric wire through hole 32 between the adjacent electric wire through holes 32 (a right side of the left electric wire through hole 32 and a left side of the right electric wire through hole 32) is in sufficient close contact with each electric wire 22, and therefore, a waterproof property is improved as compared with the related art.

That is, according to the present embodiment, both manufacturing workability and waterproof property can be achieved as described above.

Further, according to the present embodiment, the pair of wall portions 33a of the recessed portion 33 each have a curved shape along a peripheral edge of each of the adjacent electric wire through holes 32 adjacent to each wall portion 33a, so that pressure substantially equal to that applied to other portions is applied between the adjacent electric wire through holes 32 in the packing 30.

Further, according to the present embodiment, the wall portion 33a covers a half circumference of the peripheral edge of the electric wire through hole 32 in a rear view, so that pressure substantially equal to that applied to other portions is applied between the adjacent electric wire through holes 32 in the packing 30.

### Other Embodiments

The present invention is not limited to the embodiment described above and can be appropriately modified, improved and the like. In addition, materials, shapes, sizes, numbers, arrangement positions and the like of components in the embodiment described above are freely selected and are not limited as long as the present invention can be implemented.

Here, features of the embodiment of the connector according to the present invention described above are briefly summarized and listed in the following [1] to [3].

[1] A connector (1) includes:
a housing (10);
a plurality of terminals (21) that are respectively connected to a plurality of electric wires (22) and are accommodated in the housing (10);
a packing (30) that is attached to the plurality of electric wires (22) in a manner of collectively packing the plurality of electric wires (22) and is accommodated in the housing (10); and
a holder (40) that is assembled to the housing (10) and restricts separation of the packing (30) from the housing (10), wherein
the packing (30) includes a plurality of electric wire through holes (32) through which the plurality of electric wires (22) are respectively inserted and a recessed portion (33) located between the adjacent electric wire through holes (32) among the plurality of electric wire through holes (32), and
the holder (40) includes a protrusion portion (44) to be fitted into the recessed portion (33) of the packing (30).

According to the configuration of the above [1], since the packing is attached in a manner of collectively packing the plurality of electric wires, manufacturing workability is improved as compared with a case where a plurality of packings are respectively attached to a plurality of electric wires.

Here, in the packing that is attached in a manner of collectively packing a plurality of electric wires, in general, a bias is likely to occur in pressure applied from an inner wall or the like of a housing. In particular, pressure applied between adjacent electric wire through holes in the packing tends to be smaller than that applied to the other portions, and a hole edge of each electric wire through hole may be not in sufficient contact with each electric wire. However, according to this configuration, the recessed portion is provided in the packing between the adjacent electric wire through holes among the plurality of electric wire through holes, and the protrusion portion of the holder is fitted into the recessed portion, so that pressure substantially equal to that applied to the other portions is applied between the adjacent electric wire through holes in the packing. Accordingly, a side of the hole edge of each electric wire through hole between the adjacent electric wire through holes is in sufficient close contact with each electric wire, and therefore, a waterproof property is improved as compared with the related art.

That is, according to this configuration, both manufacturing workability and waterproof property can be achieved as described above.

[2] The connector (1) according to the above [1], in which [2]
the recessed portion (33) includes a pair of wall portions (33a) facing each other in an arrangement direction (a left-right direction) of the plurality of electric wire through holes (32), and the pair of wall portions (33a) each have a curved shape along a peripheral edge of each of the adjacent electric wire through holes (32) adjacent to each wall portion.

According to the configuration of the above [2], the pair of wall portions of the recessed portion facing each other in the arrangement direction each have a curved shape along a peripheral edge of each of the adjacent electric wire through holes adjacent to each wall portion, so that pressure substantially equal to that applied to other portions is applied between the adjacent electric wire through holes in the packing.

[3] The connector (1) according to the above [2], in which
each of the pair of wall portions (33a) is formed in a semicircular arc shape so as to cover a half circumference of the peripheral edge of electric wire through hole (32).

According to the configuration of the above [3], since a half circumference of the peripheral edge of the electric wire through hole is covered with the wall portion, pressure substantially equal to that applied to other portions is applied between the adjacent electric wire through holes in the packing.

What is claimed is:

1. A connector comprising:
a housing;
a plurality of terminals that are respectively connected to a plurality of electric wires and are accommodated in the housing;
a packing that is attached to the plurality of electric wires in a manner of collectively packing the plurality of electric wires and is accommodated in the housing; and
a holder that is assembled to the housing and restricts separation of the packing from the housing, wherein
the packing includes a plurality of electric wire through holes through which the plurality of electric wires are respectively inserted and a recessed portion located between the adjacent electric wire through holes among the plurality of electric wire through holes, and
the holder includes a protrusion portion to be fitted into the recessed portion of the packing.

2. The connector according to claim 1, wherein
the recessed portion includes a pair of wall portions facing each other in an arrangement direction of the plurality of electric wire through holes, and
the pair of wall portions each have a curved shape along a peripheral edge of each of the adjacent electric wire through holes adjacent to wall portion.

3. The connector according to claim 2, wherein
each of the pair of wall portions is formed in a semicircular arc shape so as to cover a half circumference of the peripheral edge of electric wire through hole.
